(19) United States
(12) Patent Application Publication
(10) Pub. No.: US 2015/0250321 A1
(43) Pub. Date: Sep. 10, 2015

(54) KNEE SUPPORT

(71) Applicant: Donald Franklin Perry, Coaldale (CA)

(72) Inventor: Donald Franklin Perry, Coaldale (CA)

(21) Appl. No.: 14/196,612

(22) Filed: Mar. 4, 2014

(51) Int. Cl. A47C 16/04; A61G 5/14

(52) U.S. Cl. CPC A47C 16/04; A61G 5/14

(57) ABSTRACT

An apparatus for supporting and assisting a user to get into and out of a kneeling position comprises a platform extending between first and second edges, each edge having two corners, a frame accommodating the platform therebetween and at least one biased arm extending between the platform and the frame, the biased arm being adapted to bias the platform from a first position located proximate to a ground surface to a second position vertically spaced above the first position.

### BACKGROUND OF THE INVENTION

1. Field of Invention

The present invention relates to support devices in general and in particular to a method and apparatus for supporting and assisting a user to get into and out of a kneeling position.

2. Description of Related Art

Kneeling is a position which is frequently difficult or uncomfortable for many people. Many people have difficulty with the act of getting into and staying in a kneeling position. In particular, many people find remaining in a kneeling position to be hard on the outer surface of their knees. This is particularly the case where the person is kneeling on rough or hard surfaces.

A further difficulty many people experience is the act of lowering themselves into a kneeling position from a standing position. It will also be appreciated that the movement of returning to standing from a kneeling position is likewise similarly difficult for such people. Such movements may be difficult for people either due to reduced muscular strength or due to injury or weakness within their knees themselves. For other people, the movement into and out of a kneeling position places a painful level of strain on their back.

Previous attempts have been made to provide knee supports for a user so as to reduce the difficulty required to get into and out of as well as remain in a kneeling position. Some attempts have been made to provide a padded surface on which the user may kneel. Such devices have located such surface at a fixed position which does not however aid the user in getting into and out of the kneeling position. Examples of such devices may be found in U.S. Pat. No. 4,763,756 issued Aug. 16, 1988 to Horan.

### SUMMARY OF THE INVENTION

According to a first embodiment of the present invention there is disclosed an apparatus for supporting and assisting a user to get into and out of a kneeling position comprising a platform extending between first and second edges, each edge having two corners, a frame accommodating the platform therebetween and at least one biased arm extending between the platform and the frame, the biased arm being adapted to bias the platform from a first position located proximate to a ground surface to a second position vertically spaced above the first position.

The apparatus may further comprise an upright located proximate to each of the corners of the first and second edges of the platform wherein the uprights located proximate to two corners of a common edge of the platform are connected by a top connecting portion.

The platform may be supported at the second position at an angle with a rear edge of the platform being lower than a corresponding front edge. The angle may be selected to be between 0 and 30 degrees.

The frame may include stoppers for supporting the platform in the first position. The arm may be collapsible. The arm may comprise first and second arm portions with a pivot therebetween. The pivot may be biased to extend the arm. The pivot may include a spring. The spring may comprise a torsion spring.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for supporting a user in a kneeling position according to a first embodiment of the present invention.

FIG. 2 is a side view of the apparatus when viewed from the direction shown by the block arrow in FIG. 1.

FIG. 3 is a view of the apparatus as in FIG. 1 when in use by the user and the platform is in the down-position. FIG. 4 is an elevation view of the apparatus as in FIG. 1 when in a folded configuration.

### DETAILED DESCRIPTION

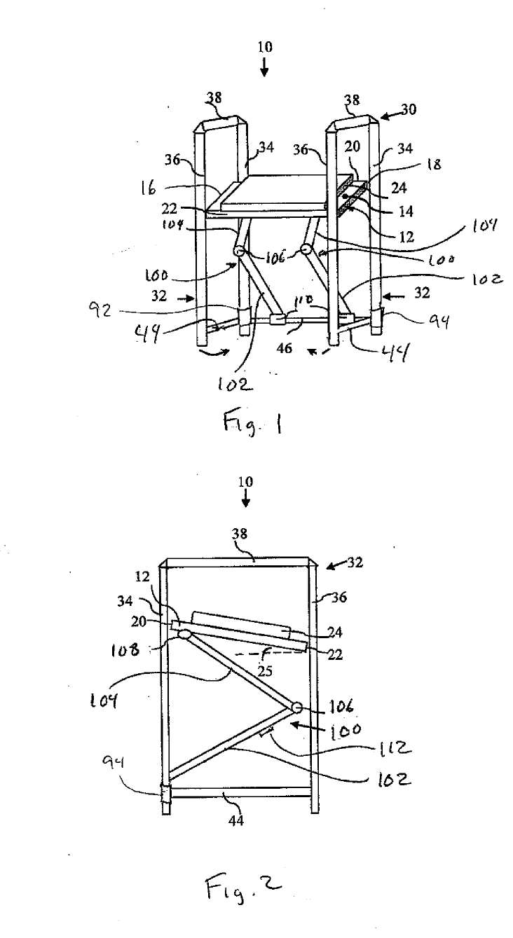

Referring to FIG. 1, an apparatus for supporting the knees of a user according to a first embodiment of the invention is shown generally at 10. The apparatus comprises a platform 12 slidably supported within a frame 30 and having a top surface 14 to receive and support the knees of a user thereon. The platform 12 is moveable between lowered and raised positions and is biased by a biasing arms 100 to the raised position as will be more fully described below.

The platform 12 extends between first and second side edges, 16 and 18, respectively and front and rear edges 20 and 22, respectively. The platform 12 may optionally include padded portions 24 on the top surface 14 thereof sized and positioned to receive the knees of a user thereon which may comprise a portion or the entire top surface of the platform. The platform 12 may be substantially rectangular as illustrated or any other suitable outline, such as, by way of non-limiting example, square, oval, circular, octagonal, hexagonal or irregular. The platform may be formed of any suitable material, such as, by way of non-limiting example wood, metal, plastic or composite materials and may have a thickness sufficient to support the weight of the user thereon. The platform 12 will further have a size selected to be able to receive a user thereon while permitting such a user to grasp the top portions of the frame for support. In practice, it has been found that a width of between 6 and 12 inches (152 and 305 mm) and a length of between 18 and 30 inches (457 and 762 mm) has been useful although it will be appreciated that other dimensions for the platform may be useful as well. The platform 12 may be angularly oriented, by an angle, generally indicated at 25 such that the front edge 20 is higher than the rear edge 22. The angle 25 assists in providing a more comfortable position for the user and may be selected to be any angle between 0 and 30 degrees.

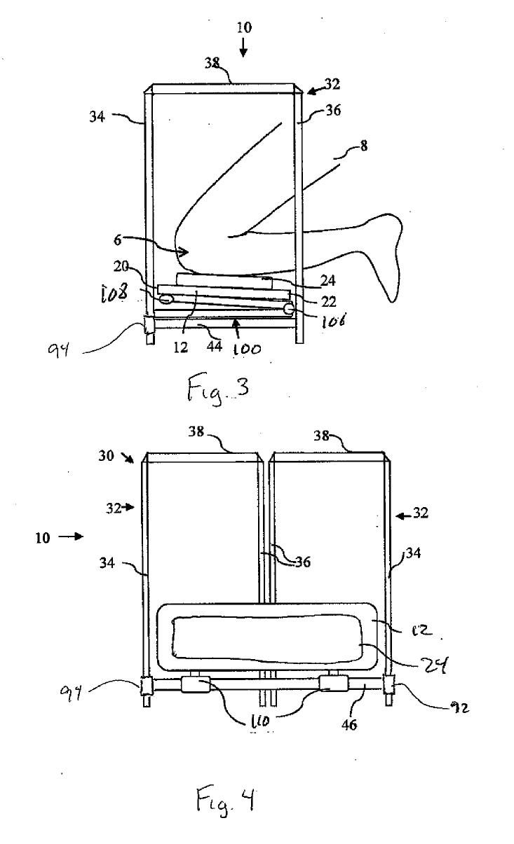

The frame 30 comprises a pair of parallel space spaced apart inverted u-shaped members 32 each comprising front and rear uprights, 34 and 36, respectively with a top connecting portion 38 between the top ends thereof. As illustrated in FIGS. 2 and 3, the front and rear uprights 34 and 36 and the top connecting portions 38 may be formed of substantially tubular members as are commonly known although non-hollow or solid members may also be utilized. As illustrated the front and rear uprights 34 and 36 and the top connecting portions 38 may be substantially tubular, although it will be appreciated that other cross-sectional shapes may be useful as well, such as, by way of non-limiting example, square, oval, rectangular, or irregular. The front and rear uprights 34 and 36 are substantially parallel to each other so as to support the platform therebetween at a plurality of locations therealong. Optionally, the frame may include bottom braces 44 extending between bottom portions of the front and rear uprights and a front brace 46 extending between the two u-shaped members 32 to provide additional stability to the apparatus. Furthermore, the frame 30 may optionally include selectably connectable extensions extending from the bottom end thereof so as to permit a user to adjust the height of the apparatus 10 as are commonly known in the art. The front and rear uprights 34 and 36 will be selected to have a height sufficient to position the top connecting portion 38 at a height that may be grasped by a user. In practice it has been found that a height of between 18 and 30 inches (457 and 762 mm) has been useful although it will be appreciated that other heights dimensions may be useful as well. The frame 30 may be formed of any suitable material, such as, by way of non-limiting example, metal, wood, plastic, or composite materials.

The front brace 46 may extend between first and second collars 92 and 94, respectively surrounding a portion of the front uprights 34. The first and second collars 92 and 94 may be rotatable around the front uprights so as to permit the u-shaped members 32 to be rotated relative thereto in a direction generally indicated at 96. It will be appreciated that such rotation will permit the apparatus 10 to be folded substantially flat for ease of storage and transportation as illustrated in FIG. 4. It will be appreciated that the frame 30 may be useful for hanging other objects, such as, by way of non-limiting example, tool trays or holders as are commonly known in the art.

The collapsible arms 100 extend between the front brace 46 and the platform 12. Each arm 100 comprises a first and a second arm portion, 102 and 104, respective with a center hinge 106 therebetween. The center hinge 106 will include a biasing element, such as, by way of non-limiting example, a torsion spring therein adapted to bias the first and second arms 102 and 104 to the extended or second position illustrated in FIGS. 1 and 2. The second arm portions 104 are rotatably attached to the platform 12 by first end hinges 108. The first arm portions 102 are rotatably attached to the front brace 46 by second end hinges 110. Optionally, the first and second end hinges 108 and 110 may also include torsion springs or other rotational biasing or resistive devices therein. When the user 8 presses down the platform 12 by the knees 6, the platform 12 is slowly brought down to the down or first position as illustrated in FIG. 3 while biasing the torsion springs within the hinge connection 106. In this position, the arms 100 collapse with the aids of the hinge connection and first and second end hinges 108 and 110. When the user 8 attempts to stand up, the platform 12 is urged to slowly return to the up or second position under the bias of the torsion springs within the center hinge 106 and/or first and second end hinges 108 and 110.

Although two arms 100 are shown herein, according to other embodiments a single arm or more than two arms may be used as well. The arms shown in this embodiment has a single fold at a center thereof. Multiple folds may be useful as well, such as with an arm arranged in a zigzag shape. The center hinge 106 and first and second end hinges 108 and 110 may also be adapted to have range of a range of motion limited to position the platform 12 at providing the desirable angle 25 when in the up-position as shown in FIG. 2, for the convenience of the user 8 as set out above.

The arms 100 may be formed of any suitable material, such as, by way of non-limiting example, metal, plastic or composite materials. The arms have sufficient resilience to permit the platform 12 to be brought down to the down-position from the up-position under the weight of the knees 6 of the user 8 and to permit the platform 12 to be brought back to the up-position when the user 8 tends to stand up. As illustrated in FIG. 2, stoppers 112 may be provided on the bottom of the first arm portions 102 for resting the platform 12 in the down-position.

In operation, a user approaches the apparatus from the rear and places their knees 6 upon the pads 24. The user then permits their weight to press the platform downward to the position illustrated in FIG. 3 which may be utilized for working in any location for which kneeling is required. When the user is completed with their kneeling task, they may slowly stand up such that the arms 100 urge the platform to the topmost position shown in FIG. 2 and thereby assisting the user in standing. Optionally, the user may grasp the top connecting portions 38 of the u-shaped members to provide them with additional stability during such movements

The arms 100 may be selected to provide a suitable bias based upon the intended user 8 and the amount of assistance required by such person to return to the standing position. In practice, it has been found that arms 100 providing between 10 and 200 pounds of lift to the platform 12 will be sufficient although other biasing forces will be useful as well.

The pair of the inverted u-shaped members 32 are connected by at least one front brace 46 preferably towards the bottom for better stability. Additional front braces 46 may be used as well. Optionally, the frame 30 may include more bottom braces 44 extending between the bottom portions of the front and the rear uprights 34 and 36 to provide additional stability to the apparatus 10.

According to a further embodiment of the apparatus 10, the first end hinges 108 and center hinges 106 may be releasably locked in the first or down position as illustrated in FIG. 3 and then rotated relative to the front brace 46 so as to orient the platform 12 in a substantially vertical position. Thereafter, the u-shaped members 32 may then be turned by about 90 degrees with respect to the front brace 46 and folded behind the folded assembly of the platform 12 and the resilient member 21, such that the resilient member 21 is accommodated between the platform 12 and the two u-shaped members 32. It will be appreciated that folding the apparatus 10 will permit ease of storage and transportation. The releasably locking mechanism may be any mechanism available in the art, such as a latching system, pins or the like.

For the above embodiments as described with the apparatus 10, the frame 30 may be provided with features to adjust the height of the platform 12, to suit the height of the user 8. The frame 30 may optionally include features (not shown) to permit the user 8 to adjust the height of the apparatus 10 as are commonly known in the art, such as with the use of telescopic members in the front and rear uprights 34 and 36. It will also be appreciated that the frame 30 may also be useful for hanging other objects, such as, by way of non-limiting example, tool trays or holders as are commonly known in the art.

While specific embodiments of the invention have been described and illustrated, such embodiments should be considered illustrative of the invention only and not as limiting the invention as construed in accordance with the accompanying claims.

What is claimed is:

1. An apparatus for supporting and assisting a user to get into and out of a kneeling position, said apparatus comprising:
a platform extending between first and second edges, each edge having two corners;
a frame accommodating said platform therebetween; and
at least one biased arm extending between said platform and said frame, said biased arm being adapted to bias said platform from a first position located proximate to a ground surface to a second position vertically spaced above said first position.

2. The apparatus of claim 1 further comprising an upright located proximate to each of said corners of said first and second edges of said platform wherein said uprights located proximate to two corners of a common edge of said platform are connected by a top connecting portion.

4. The apparatus of claim 3 wherein said platform is supported at said second position at an angle with a rear edge of said platform being lower than a corresponding front edge.

5. The apparatus according to claim 4 wherein said angle is selected to be between 0 and 30 degrees.

6. The apparatus according to claim 1 wherein said frame includes stoppers for supporting said platform in said first position.

7. The apparatus of claim 1 wherein said arm is collapsible.

8. The apparatus of claim 7 wherein said arm comprises first and second arm portions with a pivot therebetween.

9. The apparatus of claim 8 wherein said pivot is biased to extend said arm.

10. The apparatus of claim 9 wherein said pivot includes a spring.

11. The apparatus of claim 10 wherein said spring comprises a torsion spring.
